(19) United States
(12) Patent Application Publication
(10) Pub. No.: US 2013/0124365 A1
(43) Pub. Date: May 16, 2013

(54) DYNAMIC MERCHANDISING CONNECTION SYSTEM

(71) Applicant: Anantha Pradeep, Piedmont, CA (US)

(72) Inventor: Anantha Pradeep, Piedmont, CA (US)

(21) Appl. No.: 13/294,080

(22) Filed: Nov. 10, 2011

(51) Int. Cl. G06Q 30/06

(52) U.S. Cl. 705/26.43

(57) ABSTRACT

Mechanisms are provided for efficiently and effectively connecting users such as customers, consumers, and clients with remote agents such as salespeople, assistants, personal shoppers, etc., by using a merchandising interface in store, shop, and showroom environments. A merchandising connection system identifies and analyzes characteristics of users, target products, and remote agents, and matches users and remote agents using data such as demographic information, common interests, compatible personality types, areas of expertise, attractiveness levels, etc. Various sensors, detectors, actuators, scent emitters, etc., at the merchandising interface work to enhance the user and remote agent connection.

### TECHNICAL FIELD

The present disclosure relates to a dynamic merchandising and sales connection system.

### DESCRIPTION OF RELATED ART

Conventional mechanisms for merchandising and sales in store isle and shop environments are limited. Some mechanisms include banner advertisements, demonstration displays, live salespeople, video presentations, live demonstrations, interesting signage, etc. Other mechanisms focus on improved product and service presentation including better packaging, easier access to information, ratings information, etc. These mechanisms have proved to be moderately effective in increasing purchase transactions in store, shop, and retail environments. However, each of these mechanisms are severely.

In an environment where online stores are gradually consuming an ever larger slice of the retail sales pie, it is important to provide improved mechanisms for enhancing the retail experience, efficiently promoting products and services, while effectively controlling costs. Consequently, it is desirable to provide improved mechanisms for enhancing and improving merchandising and sales connection mechanisms.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of system that can be used to implement various mechanisms of the present invention.

FIG. 2 illustrates a particular example of a connection terminal.

FIG. 3 illustrates a particular example of a technique for initiating merchandising and sales connections.

FIG. 4 illustrates a particular example of a technique for enhancing merchandising and sales connections.

FIG. 5 illustrates a particular example of a server.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular transactions and retail environments. However, it should be noted that the techniques and mechanisms of the present invention apply to a variety of different transactions and retail environments. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Mechanisms are provided for efficiently and effectively connecting users such as customers, consumers, and clients with remote agents such as salespeople, assistants, personal shoppers, etc., by using a merchandising interface in store, shop, and showroom environments. A merchandising connection system identifies and analyzes characteristics of users, target products, and remote agents, and matches users and remote agents using data such as demographic information, common interests, compatible personality types, areas of expertise, attractiveness levels, etc. Various sensors, detectors, actuators, scent emitters, etc., at the merchandising interface work to enhance the user and remote agent connection.

### Example Embodiments

Current techniques for enhancing store isle and brick and mortar shop experiences are limited. In some examples, live salespeople present samples or answer questions about a particular product or service in store environments. In other examples, video displays show presentations, advertisements, or testimonials about products and services in store environments. However, each of these mechanisms has limitations. Banner advertisements may not effectively convey messages to interested consumers. Live salespeople may have personality clashes with customers. Video presentations may show irrelevant material. Consequently, it is desirable to provide an improved merchandising connection system.

According to various embodiments, supermarkets, retail stores, shop aisles, showrooms, etc., are equipped with output interfaces such as displays, speakers, projectors, moveable racks, etc., as well as input interfaces such as microphones, cameras, sensors, detectors, etc. When a merchandising connection system detects that a consumer is nearby or interested in a particular product, or if the consumer activates that merchandising connection system, the consumer is automatically connected with a remote individual intelligently selected to suit the consumer's needs. In some examples, remote agents such as remote salespeople, remote shoppers, and other individuals are selected to match a particular consumer's likeness, including age, hairstyle, clothing selection, etc. The remote individuals may be salespeople, assistants, personal shoppers, information specialists, or even third party advisors.

In particular embodiments, proximity to a display automatically triggers connection with a remote assistant. The remote assistant may be able to identify the item of interest, the level of interest, and the other items the consumer has surveyed. The remote assistant can offer to answer any questions the consumer may have, provide the consumer with advice, or merely sign off if requested by the consumer. The remote assistant may also identify an even more appropriate remote assistant that could serve the consumer even more effectively. In some examples, the consumer may not only have questions about a product, but may have technical questions about the safety, chemical composition, or origins of a product. In other examples, the consumer may want a personal shopper to assist in selecting items for an ensemble.

The consumer may even be provided with the option of selecting one or more available remote assistants. If a particular assistant is selected by a different consumer, a different option may appear. In some examples, a merchandising connection system may identify particular users and provide remote agents who the consumer has interacted with positively in the past.

According to various embodiments, characteristics of particular consumers, products, stores, shop aisles, etc., are identified and matched to skill sets, personality traits, expertise areas, etc., of remote salespeople, assistants, researchers, actors, etc. In particular embodiments, pools of remote salespeople are made available for interaction with customers. In some examples, these pools of people are selected based on charisma. In some examples, these remote assistants are selected based on likeness with a particular customer. In still other examples, the remote assistant images are modified to make them more appealing to customers.

In some examples, biometric data can also be obtained from individual customers and provided to remote salespeople and assistants to further improve merchandising connections. Remote agents such as salespeople and assistants may be demographically diverse and may be located in a various geographic locations. Linguistic preferences, age, hairstyle, clothing, height, income level, interests, etc., can all be used to automatically select appropriate remote agents for customers browsing store aisles, shops, and showrooms.

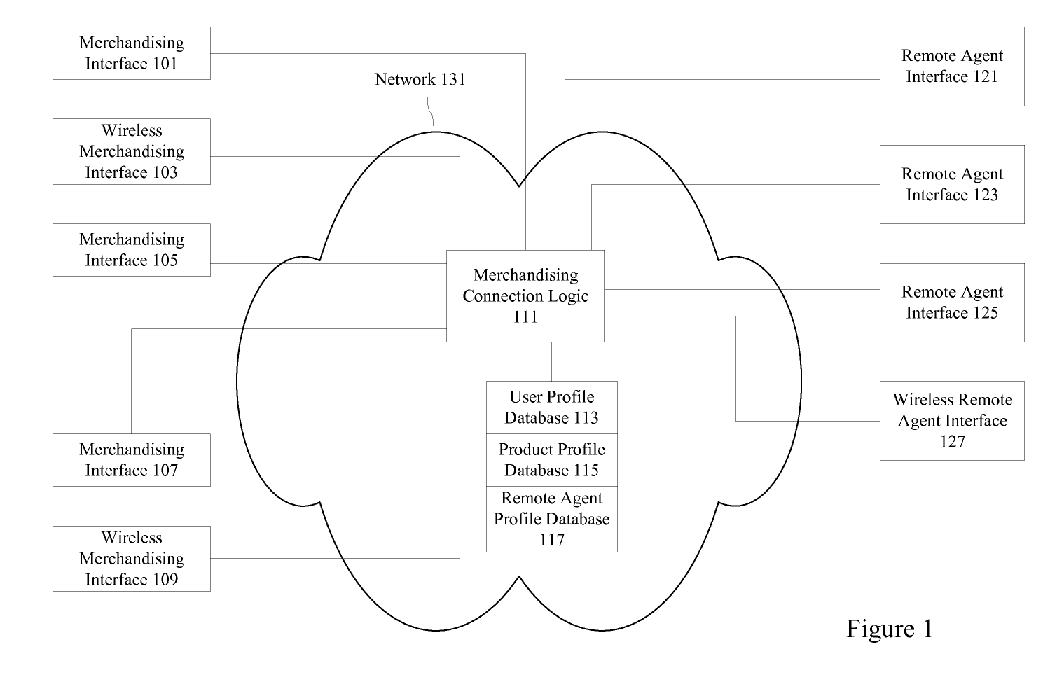

FIG. 1 illustrates one example of a dynamic merchandising connection system. A variety of merchandising interfaces 101, 103, 105, 107, and 109 may be located in store aisles, shops, showrooms, real estate properties, or provide on mobile devices. These merchandising interfaces 101, 103, 105, 107, and 109 may be wired or wireless. Wired interfaces may provide higher throughput, but wireless interfaces may allow for greater mobility. According to various embodiments, merchandising interfaces 101, 103, 105, 107, and 109 have displays, sensors, cameras, microphones, motion detectors, infrared sensors, scent emitters, etc., that enhance an interactive experience between a user and a remote agent. Merchandising interfaces 101, 103, 105, 107, and 109 may be activated by a user manually or automatically based on proximity detection or motion detection. In particular embodiments, merchandising interfaces 101, 103, 105, 107, and 109 may always be active and may have a particular remote agent associated with it.

For example, a display corresponding to a home entertainment system may be shown alongside a merchandising interface 107. If a potential customer has questions about the home entertainment system, the questions may be directed at the remote agent. The remote agent may have expertise in home entertainment systems and have access to pricing and availability information as well as other remote agents with different areas of expertise. According to various embodiments, the merchandising interfaces 101, 103, 105, 107, and 109 are connected over a network 131 to merchandising connection logic 111 in a merchandising connection system. In particular embodiments, the merchandising connection logic 111 matches particular merchandising interfaces 101, 103, 105, 107, and 109 at particular times with remote agent interfaces 121, 123, 125, and 127.

According to various embodiments, the remote agent interfaces 121, 123, 125, and 127 are located in call centers, remote agent centers, or may be distributed to individual remote agent homes on terminals, computer systems, and mobile devices. Merchandising connection logic 111 connects wired and wireless merchandising interfaces 101, 103, 105, 107, and 109 to remote agent interfaces 121, 123, 125, and 127. In some instances, merchandising interfaces 101, 103, 105, 107, and 109 have predetermined connections. In other examples, merchandising interfaces 101, 103, 105, 107, and 109 are dynamically connected with particular selected remote agent interfaces 121, 123, 125, and 127 at particular times.

According to various embodiments, the merchandising connection logic 111 may be one or more computer systems, switches, controllers, etc. Merchandising connection 111 may have access to a user profile database 113, a target product/service database 115, and a remote agent profile database 117. For example, the merchandising connection logic 111 may determine that a product of interest for a particular demographic profile can be sold most effectively if matched to a particular remote agent. Alternatively, a user may request a remote agent having expertise in a particular category of services. In still other examples, merchandising connection logic 111 may connect consumers with agents having similar backgrounds and interests.

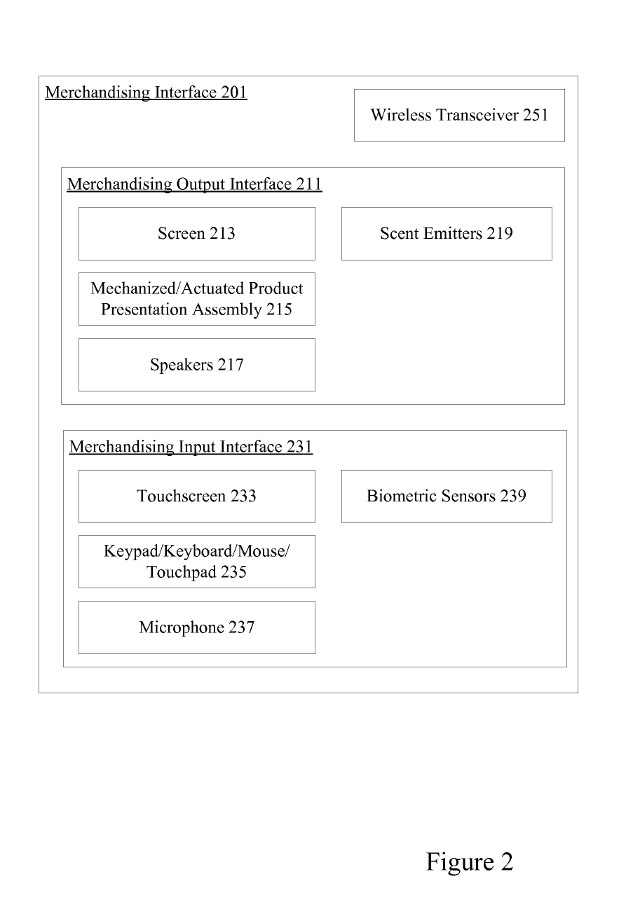

FIG. 2 illustrates one example of a merchandising interface 201. The merchandising interface 201 operates to allow interaction between a consumer and a remote agent and makes interaction efficient and effective by obtaining information that may not be readily accessible to in store salespeople. According to various embodiments, the merchandising interface 201 includes an output interface 211 with a screen/display/projector 213, a mechanized/actuated product presentation assembly 215, speakers 217, and scent emitters 219. The merchandising interface 201 may also have an input interface 231 that includes a touchscreen 233, keypad/keyboard/mouse/touchpad input 235, a microphone 237, and biometric sensors 239. The merchandising interface 201 also has a wireless transceiver 251 or a wired interface that allows connection to remote agents.

According to various embodiments, a consumer can manually active a merchandising interface 201 by interacting with touchscreen 233 or keypad/keyboard/mouse/touchpad 235. Proximity sensors, motion detectors, or other biometric sensors 239 as well as noise detectors and microphones 237 can also trigger activation as well as acquire information about the consumer. The merchandising interface 201 may be able to help identify what product the consumer is currently evaluating, the level of interest and excitement, the duration of interest, etc. According to various embodiments, the merchandising interface 201 may also be able to obtain information identify if a particular consumer has viewed the product before.

In particular embodiments, remote agents can speak with customers through merchandising output interface 211 and speakers 217. If a remote agent determines that another product or service may be of interest, a mechanized/actuated product presentation assembly 215 may be activated to present a different product. Scent emitters 219 may be used to enhance a consumer's experience based on perceived mood. It should be noted that although particular interfaces are described, a wide variety of sensors, displays, motors, sensory input mechanisms, etc., can be used to enhance a consumer and remote agent connection.

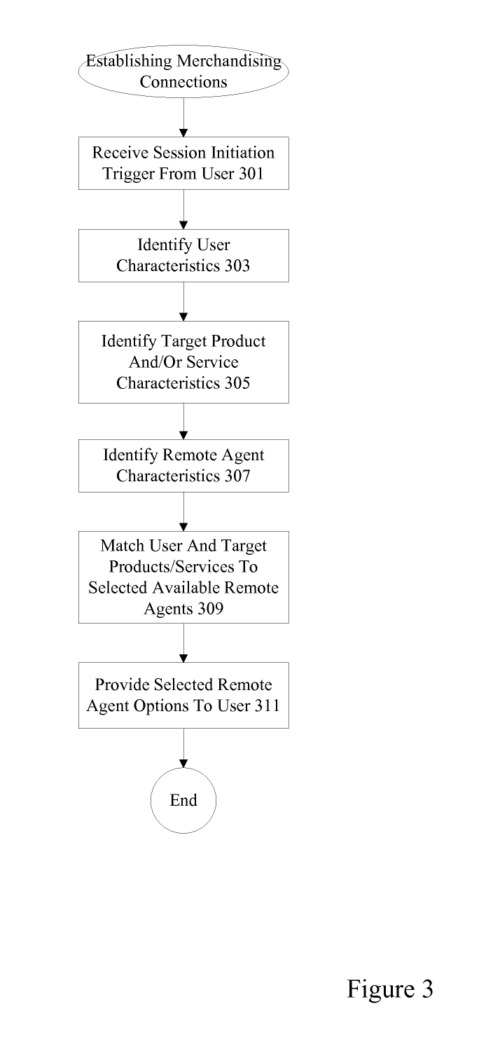

FIG. 3 illustrates a particular example of a technique for establishing merchandising connections. According to various embodiments, a session initiation trigger is received from a user at 301. The trigger may result from motion activation, proximity activation, a key press, voice prompt, etc. Alternatively, a trigger may not be needed as a connection system is always online and a remote agent is constantly on standby. According to various embodiments, user characteristics are identified at 303. In particular embodiments, a connection system may perform facial recognition to determine if the user has perused the store or has evaluated the product before. The connection system may also identify demographic profile information about the user, such as the age of the user, gender, height, weight, ethnicity, etc. In some examples, users may voluntarily provide information to the connection system to allow the connection system to more accurately select remote agents that would be appropriate for the user.

According to various embodiments, users can select preferences for remote agent characteristics, such as calm demeanor, talkative, attractive, technically adept, etc. The users can also provide information on interests, income levels, preferences, etc. According to various embodiments, target product and/or service characteristics are also identified at 305. For example, the target product may require a remote agent with expertise in electronics or may require a remote agent with good style sense.

At 307, remote agent characteristics are identified. According to various embodiments, remote agent characteristics such as demographic information, areas of expertise, personality type, etc., are identified. Remote agent characteristics, product/service characteristics, and user characteristics are evaluated to match users to selected remote agents at 309. In particular embodiments, selected remote agent options are provided to the user at 311. In some examples, remote agents are automatically selected without any input from the user. In still other examples, remote agents are assigned to particular products and associated merchandising interfaces.

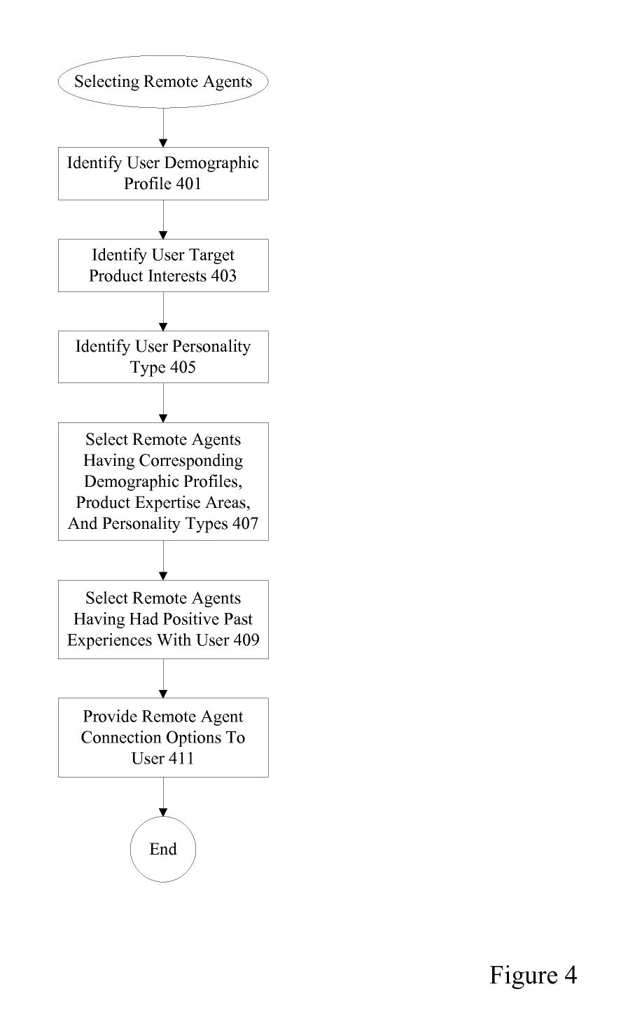

FIG. 4 illustrates a particular example of a technique for selecting remote agents. At 401, user demographic information is identified. At 403, user target product interests are identified. At 405, user personality type is identified. At 407, remote agents having corresponding demographic profiles, product expertise areas, and compatible personality types are selected.

In some examples, user interactions with remote agents are stored so that future efforts will be made to match the same user with the same remote agent at 409. At 411, remote agent connection options are provided to the user.

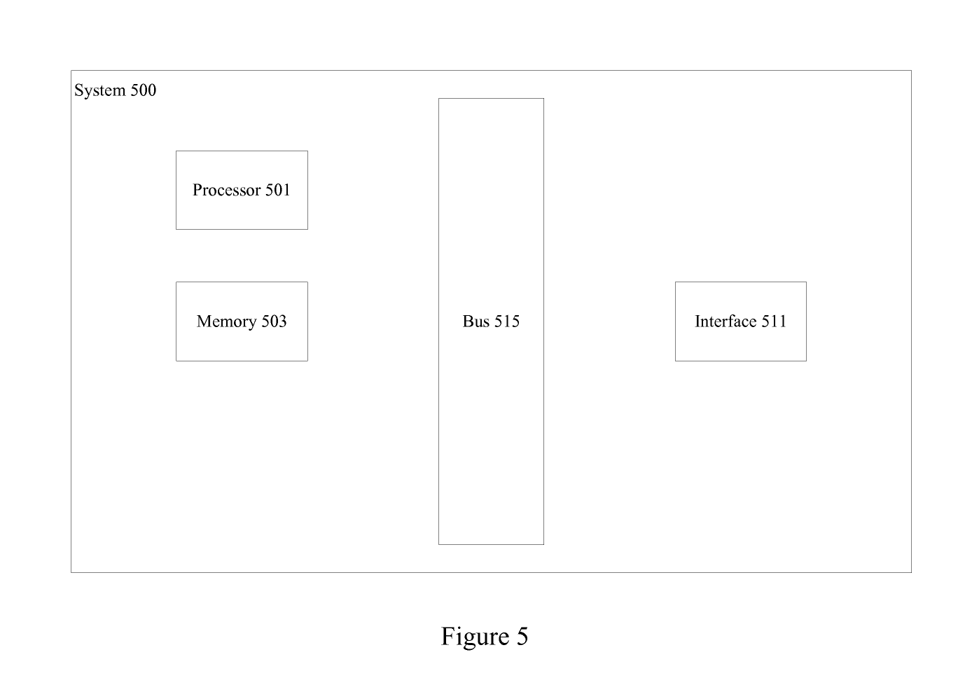

FIG. 5 illustrates a particular example of a server that can be used to select remote agents. A variety of devices and systems can implement particular examples of the present invention. According to particular example embodiments, a system 500 suitable for implementing particular embodiments of the present invention includes a processor 501, a memory 503, an interface 511, and a bus 515 (e.g., a PCI bus). The interface 511 may include separate input and output interfaces, or may be a unified interface supporting both operations. When acting under the control of appropriate software or firmware, the processor 501 is responsible for such tasks such as optimization. Various specially configured devices can also be used in place of a processor 501 or in addition to processor 501. The complete implementation can also be done in custom hardware. The interface 511 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 900 uses memory 903 to store data and program instructions and maintained a local side cache. The program instructions may control the operation of an operating system and/or one or more applications, for example. The memory or memories may also be configured to store received metadata and batch requested metadata.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

1. A method, comprising:
receiving a session initiation trigger from a merchandising interface for a user evaluating a product or service, the merchandising interface corresponding to the product or service, the merchandising interface including a display, a speaker, a microphone, and a camera;
identifying characteristics associated with the user by using a processor;
matching the user to a selected available remote agent using merchandising connection logic by using characterisics including an image associated with the user, the selected available remote agent having expertise in the product or service;
receiving communications between the user and the remote agent.

2. The method of claim 1, wherein characteristics associated with the product or service are also identified.

3. The method of claim 2, wherein characteristics associated with the remote agent are also identified.

4. The method of claim 1, wherein the merchandising interface further comprises biometric sensors.

5. The method of claim 1, wherein the merchandising interface further comprises scent emitters.

6. The method of claim 1, wherein the merchandising interface further comprises a mechanized/actuated product presentation assembly for presenting to the user items selected by the selected available remote agent.

7. The method of claim 1, wherein the merchandising interface is wireless.

8. The method of claim 1, wherein the session initiation trigger results from the user interacting with the product or service.

9. The method of claim 1, wherein the session initiation trigger results from the user interacting with the merchandising interface.

10. The method of claim 1, wherein the session initiation trigger results from the user moving into close proximity to the product or service displayed.

11. A system, comprising:
an interface configured to receive a session initiation trigger from a merchandising interface for a user evaluating a product or service, the merchandising interface corresponding to the product or service, the merchandising interface including a display, a speaker, a microphone, and a camera;
a processor configured to identify characteristics associated with the user and match the user by using characterisics including an image associated with the user to a selected available remote agent using merchandising connection logic, the selected available remote agent having expertise in the product or service.

12. The system of claim 11, wherein characteristics associated with the product or service are also identified.

13. The system of claim 12, wherein characteristics associated with the remote agent are also identified.

14. The system of claim 11, wherein the merchandising interface further comprises biometric sensors.

15. The system of claim 11, wherein the merchandising interface further comprises scent emitters.

16. The system of claim 11, wherein the merchandising interface further comprises a mechanized/actuated product presentation assembly for presenting to the user items selected by the selected available remote agent.

17. The system of claim 11, wherein the merchandising interface is wireless.

18. The system of claim 11, wherein the session initiation trigger results from the user interacting with the product or service.

19. The system of claim 11, wherein the session initiation trigger results from the user interacting with the merchandising interface.

20. The system of claim 11, wherein the session initiation trigger results from the user moving into close proximity to the product or service displayed.

21. A non-transitory compute readable medium, comprising:
computer code for receiving a session initiation trigger from a merchandising interface for a user evaluating a product or service, the merchandising interface corresponding to the product or service, the merchandising interface including a display, a speaker, a microphone, and a camera;
computer code for identifying characteristics associated with the user by using a processor;
computer code for matching the user by using characterisics including an image associated with the user to a selected available remote agent using merchandising connection logic, the selected available remote agent having expertise in the product or service;
computer code for receiving communications between the user and the remote agent.
